(19) United States
(12) Patent Application Publication
(10) Pub. No.: US 2012/0241997 A1
(43) Pub. Date: Sep. 27, 2012

(54) TUBULAR MEMBER MANUFACTURING METHOD

(75) Inventors: Daisuke TANEMURA, Kanagawa (JP); Yuichi YASHIKI, Kanagawa (JP)

(73) Assignee: FUJI XEROX CO., LTD., Tokyo (JP)

(21) Appl. No.: 13/415,290

(22) Filed: Mar. 8, 2012

(30) Foreign Application Priority Data
Mar. 25, 2011 (JP) 2011-068745

(51) Int. Cl. B29D 23/00

(52) U.S. Cl. 264/214

(57) ABSTRACT

A tubular member manufacturing method includes coating the surface of a rotating core body with a resin solution to form a coating film thereon while rotating the core body with the axis direction set to be horizontal, drying the coating film by blowing air to the core body with a saturated air volume with which a drying rate of the coating film is saturated, and stripping the dried coating film from the core body.

### CROSS-REFERENCE TO RELATED APPLICATIONS

This application is based on and claims priority under 35 USC 119 from Japanese Patent Application No. 2011-068745 filed Mar. 25, 2011.

### BACKGROUND

### Technical Field

The present invention relates to a tubular member manufacturing method.

### SUMMARY

According to an aspect of the invention, there is provided a tubular member manufacturing method including: coating the surface of a rotating core body with a resin solution to form a coating film thereon while rotating the core body with the axis direction set to be horizontal; drying the coating film by blowing air to the core body with a saturated air volume with which a drying rate of the coating film is saturated; and stripping the dried coating film from the core body.

### BRIEF DESCRIPTION OF THE DRAWINGS

Exemplary embodiments of the present invention will be described in detail based on the following figures, wherein:

FIG. 1 is a diagram schematically illustrating the configuration of a coater used in a coating process (spiral coating method) according to an exemplary embodiment of the invention;

FIG. 2 is a diagram schematically illustrating the configuration of an air blower used in a drying process according to the exemplary embodiment of the invention;

FIG. 3 is a perspective view illustrating a nozzle of the air blower shown in FIG. 2;

FIG. 4 is a diagram illustrating a drying rate curve;

FIG. 5 is a diagram illustrating the relationship between a nozzle air volume and a drying rate;

FIG. 6 is a diagram schematically illustrating the configuration of a dryer used in the drying process according to the exemplary embodiment of the invention;

FIG. 7 is a diagram schematically illustrating the configuration in which the dryer used in the drying process according to the exemplary embodiment of the invention includes plural nozzles;

FIG. 8 is a diagram schematically illustrating the configuration of a heater used in a heating process according to the exemplary embodiment of the invention;

FIG. 9 is a diagram schematically illustrating the configuration of a dryer according to a comparative example;

FIG. 10 is a graph illustrating the temperature of a core body in the drying process;

FIG. 11 is a graph illustrating the surface resistivity of a manufactured intermediate transfer belt; and

FIG. 12 is a diagram schematically illustrating the flow of hot air in the configuration of the dryer according to the comparative example.

### DETAILED DESCRIPTION

Hereinafter, an example of an exemplary embodiment of the invention will be described with reference to the accompanying drawings. In the drawings, elements other than elements necessary for description are not appropriately shown for the purpose of facilitating understanding. The elements having the same functions are referenced by the same reference signs in all the drawings and description thereof may not be repeated. In this exemplary embodiment, a method of manufacturing an intermediate transfer belt as an example of a tubular member will be described as an example, but the manufacturing method according to this exemplary embodiment may be applied to manufacturing other tubular members such as a sheet feeding belt.

### Coating Process

The intermediate transfer belt manufacturing method according to this exemplary embodiment includes a drying process of coating the surface of a rotating core body with a film-forming resin solution as an example of a resin solution to form a coating film thereon while rotating the core body with the axis direction thereof set to be horizontal.

A polyimide resin (PI) or a polyamideimide resin (PAI) is used as the film-forming resin constituting the intermediate transfer belt in view of strength, size stability, and heat resistance, but the film-forming resin is not limited to these examples. Various known ones can be used as the PI or PAI. In the case of PI, a precursor thereof may be applied.

A PI precursor solution as the film-forming resin solution may be obtained by causing tetracarboxylic dianhydride and a diamine component to react with each other in a solvent. The kinds of the components are not particularly limited, but it is preferable in view of film strength that the PI precursor solution be obtained by causing aromatic tetracarboxylic dianhydride and an aromatic diamine component to react with each other.

Representative examples of the aromatic tetracarboxylic dianhydride include pyromellitic dianhydride, 3,3′,4,4′-biphenyltetracarboxylic dianhydride, 3,3′,4,4′-benzophenonetetracarboxylic dianhydride, 2,3,4,4′-biphenyltetracarboxylic dianhydride, 2,3,6,7-naphthalenetetracarboxylic dianhydride, 1,2,5,6-naphthalenetetracarboxylic dianhydride, 2,2-bis(3,4-dicarboxyphenyl)ether dianhydride, or tetracarboxylic ester thereof, and mixtures of the tetracarboxylic acids.

On the other hand, examples of the aromatic diamine component include paraphenylenediamine, meta-phenylenediamine, 4,4′-diaminodiphenyl ether, 4,4′-diaminophenyl methane, benzidine, 3,3′-dimethoxy benzidine, 4,4′-diaminodiphenyl propane, and 2,2-bis(4-(4-aminophenoxy)phenyl)propane.

On the other hand, the PAI is obtained by combining acid anhydrides such as trimellitic anhydride, ethyleneglycol bisanhydrotrimellitate, propyleneglycol bisanhydrotrimellitate, pyromellitic anhydride, benzophenonetetracarboxylic anhydride, and 3,3′4,4′-biphenyltetracarboxylic anhydride with the diamine and having them subjected to a polycondensation reaction in the equivalent molar quantity. Since the PAI has an amide group, the PAI may be easily dissolved in a solvent even in the imidization reaction and it is thus preferable that the PAI is imidized by 100%.

Polar aprotic solvents such as N-methyl pyrrolidone, N,N-dimethylacetamide, and acetamide are used as the solvent included in the film-forming resin solution. The concentration and viscosity of the solution are not particularly limited, but the solid concentration of the solution in this exemplary embodiment is preferably in the range of 10 mass % to 40 mass % and the viscosity thereof is preferably in the range of 1 Pa·s to 100 Pa·s.

Conductive particles may be added to the film-forming resin solution if necessary. Examples of the conductive particles dispersed in the resin solution include carbon materials such as carbon black, carbon fibers, carbon nanotubes, and graphite, metals such as copper, silver, and aluminum or alloys thereof, conductive metal oxides such as tin oxide, indium oxide, and antimony oxide, and whiskers such as potassium titanate. Among these, carbon black may be preferably used in view of dispersion stability in liquid, developability of semiconductivity, and cost.

Known methods using a ball mill, a sand mill (bead mill), a jet mill (counter-collision disperser), and the like may be used as the method of dispersing the conductive particles. A surfactant or a leveling agent may be added to a dispersant. The dispersion concentration of the conductive particles is preferably in the range of 10 parts to 40 parts with respect to 100 parts (parts by mass, which is true below) of a resin component and more preferably in the range of 15 parts to 35 parts.

A cylindrical core body used in this exemplary embodiment is preferably formed of stainless steel in view of processability or durability. The width (the length in the axis direction) of the core body is necessarily greater than the width of a desired tubular member, and is preferably greater by 10% to 40% than the width of a desired intermediate transfer belt so as to guarantee the margin area for an invalid area at the ends thereof. The length (circumferential length) of the core body is equal to or slightly greater than the length of a desired intermediate transfer belt.

The thickness of the core body is preferably in the range of 0.1 mm to 2 mm. When the thickness is smaller than this range, it is difficult to weld the core body. When the thickness is greater than this range, it is difficult to round the core body in a cylindrical shape. When manufacturing the core body, a rectangular metal sheet is cut in predetermined width and length, the cut metal sheet is rounded, and both ends thereof are welded to each other. As a result, a metal annular body is obtained.

When the film-forming resin is the PI resin, much gas is generated in the heating reaction of the PI precursor and a lantern-shaped expansion easily occurs partially in the PI resin film due to the generating gas. Particularly, this phenomenon is marked when the thickness of the film is greater than 50 μm. The gas generated in the heating reaction includes volatilized gas of the residual solvent and steam of water generated in the reaction.

In order to prevent the expansion, as described in JP-A-2002-160239, it is preferable that the surface of the core body be roughened with an arithmetic average roughness Ra of 0.2 μm to 2 μm. When the arithmetic average roughness Ra is smaller than 0.2 μm, the gas such as the volatilized gas or steam is not removed well. When the arithmetic average roughness Ra is greater than 2 μm, unevenness may be formed on the surface of the resultant intermediate transfer belt. The roughening may be performed using a blast method, a cutting method, and a sandpaper method. The roughening provides a merit that the roughness may be made to be uniform, since the core has a constant hardness in the sheet part and the welding part. The gas generated from the PI resin may go out externally through small pores formed between the surface of the core and the PI resin film through the roughening, thereby not causing the expansion.

Before coating the surface of the core body with the film-forming resin solution, a masking member as an example of a stripping assist member may be wound on both ends of the core body. A resin film of polyester, polypropylene, or the like or an adhesive tape using a paper material such as crepe paper or plain paper as a base material may be used as the masking member. The width of the adhesive tape is preferably in the range of 10 mm to 25 mm. An acryl-based adhesive may be preferably used as the adhesive of the adhesive tape and it is particularly preferable that the adhesive not remain on the surface of the core body after being stripped.

In this exemplary embodiment, the method of applying the film-forming resin solution is not particularly limited, but, for example, a spiral coating method may be used.

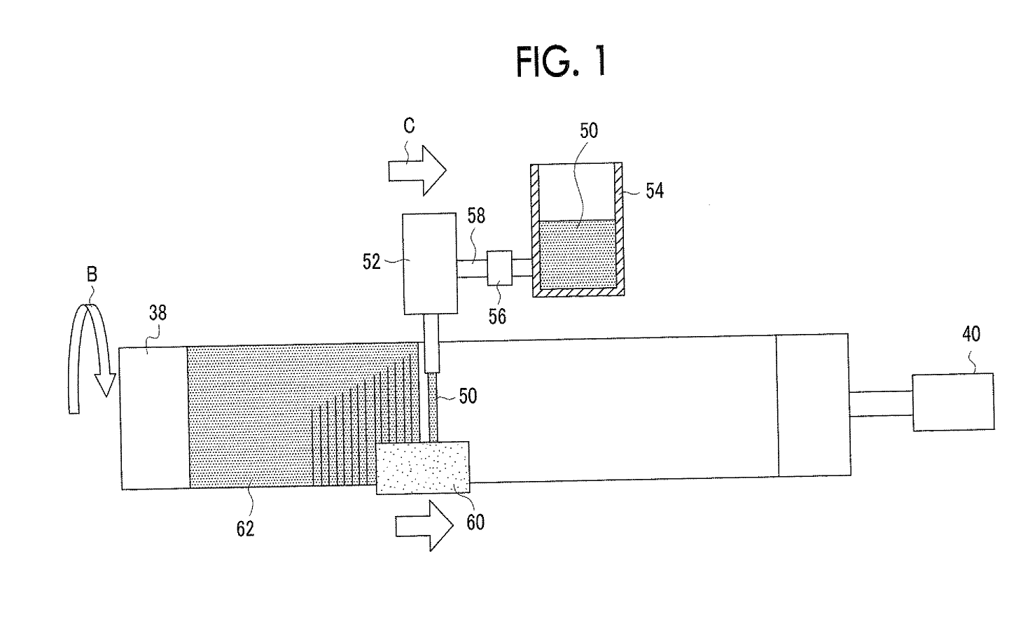

FIG. 1 is a diagram illustrating a spiral coating method. In the spiral coating method, as shown in FIG. 1, a film-forming resin solution 50 is ejected from a downward flow device 52 and is attached to the surface of a core body 38 while rotating the cylindrical core body 38 about an axis with the axis direction set to be horizontal. The film-forming resin solution 50 is supplied to the downward flow device 52 from a tank 54 containing the film-forming resin solution 50 via a supply pipe 58 by a pump 56. The film-forming resin solution 50 attached to the surface of the core body 38 is smoothed by a paddle 60. The core body 38 is rotated about the axis in the direction of arrow B with the axis direction thereof set to be horizontal by a rotating device 40.

The downward flow device 52 and the paddle 60 are supported to be movable in the axis direction of the core body 38, the film-forming resin solution 50 is applied to the surface of the core body 38 in a spiral shape by ejecting the film-forming resin solution 50 while the downward flow device 52 and the paddle 60 are moving in the axis direction (the direction of arrow C) of the core body 38 in the state where the core body 38 is rotated at a predetermined rotational speed, and the applied film-forming resin solution 50 is smoothed by the paddle 60 to remove any spiral streak, whereby a coating film 62 without any seam is formed. The thickness is set to the range of 50 μm to 150 μm in the final state, if necessary.

### Drying Process

The method of manufacturing an intermediate transfer belt according to this exemplary embodiment includes a drying process of drying the coating film by blowing air to the core body with a saturated air volume with which the drying rate of the coating film is saturated.

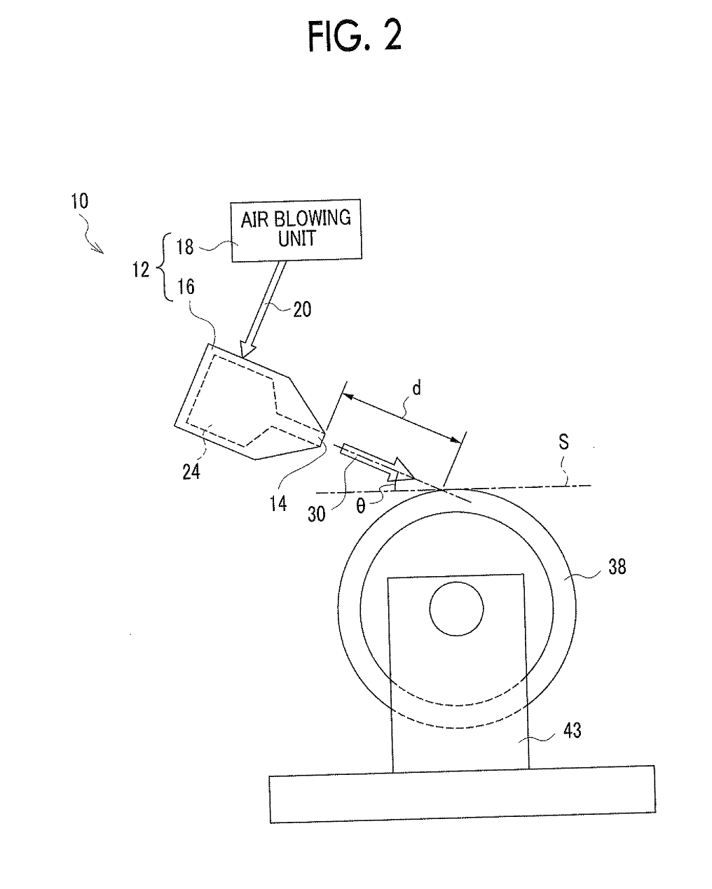

A dryer 10 used in the drying process includes an air blower 12 blowing hot air (heated air) to the core body 38, as shown in FIG. 2. The air blower 12 includes a nozzle 16 having an air blowing port 14 of a slit shape with a length in the axis direction of the core body 38 and an air blowing unit 18 including a heating unit heating air and sending air (hot air) heated by the heating unit to the nozzle 16.

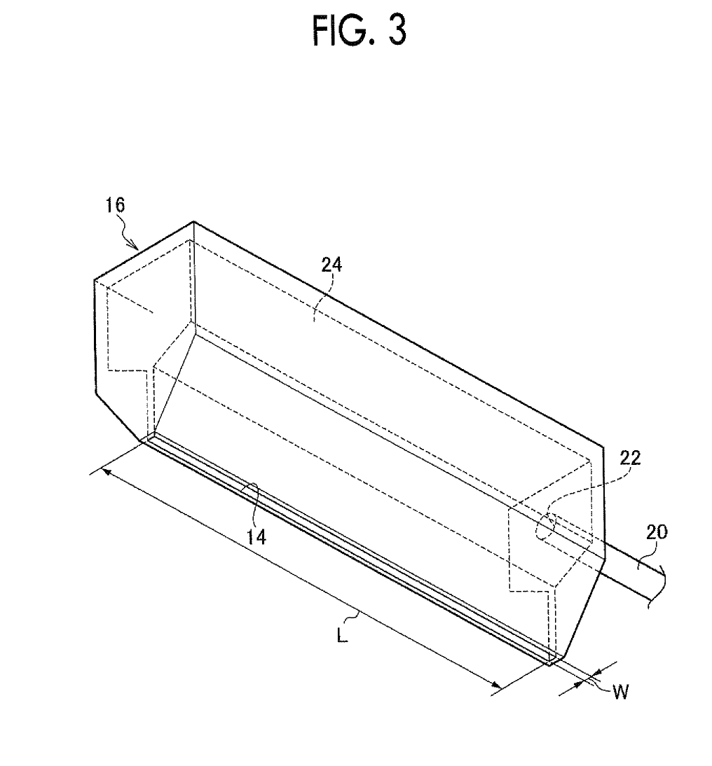

The air blowing unit 18 and the nozzle 16 are connected to each other via an air blowing pipe 20 and the hot air from the air blowing unit 18 flows in the nozzle 16 from an inlet 22 of the nozzle 16 via the air blowing pipe 20, as shown in FIG. 3.

A cavity (manifold) 24 is formed in the nozzle 16. The air pressure in the nozzle 16 is uniformized by the cavity (manifold) 24 and the wind speed of the hot air blown from the air blowing port 14 is uniformized in the length direction of the air blowing port 14. A member having air resistance such as a porous plate may be interposed between the cavity 24 and the air blowing port 14 so as to further improve the uniformity in air pressure in the cavity 24.

The length L (see FIG. 3) of the air blowing port 14 in the axis direction of the core body 38 is larger than the length in the axis direction of the core body 38. The width W (see FIG. 3) of the air blowing port 14 is, for example, in the range of 0.5 to 2 mm. When the width W is less than 0.5 mm, the air volume is reduced. When the width W is greater than 2 mm, it is difficult to maintain the uniformity of the wind speed in the axis direction. In this way, by forming the air blowing port 14 in a slit shape and setting the width W to a predetermined range, the air volume (wind speed) blown to the core body 38 is uniformized in the axis direction of the core body 38.

The hot air from the air blowing port 14 of the nozzle 16 comes in contact with the circumferential surface of the core body 38. Accordingly, the hot air blown from the air blowing port 14 flows in the circumferential direction of the core body 38 and the hot air is not split in the axis direction of the core body 38 on the surface of the core body 38. Accordingly, the hot air does not flow in the axis direction of the core body 38 and the wind speed is uniformized in the axis direction of the core body 38.

The angle θ (see FIG. 2) of a tangential line S passing through the surface position of the core body 38 with which the hot air comes in contact and the flow of hot air is in the range of 0° to 90°.

The distance d (see FIG. 2) between the air blowing port 14 and the core body 38 in the air blowing direction is set, for example, to a range of 50 to 300 mm. When the distance between the air blowing port 14 and the core body 38 is excessively small, the wind speed of the air blown out from the air blowing port 14 easily decreases while the air flows over the surface of the core body 38. When the distance between the air blowing port 14 and the core body 38 is excessively large, the air volume blown to the nozzle 16 from the air blowing unit 18 has only to be set to be very large so as to guarantee the necessary air volume.

The wind speed of the hot air coming contact with the coating film on the core body 38 is preferably, for example, in the range of 5 to 50 m/s. When the wind speed of the hot air is less than 5 m/s, the drying of the coating film is delayed. When the wind speed of the hot air is greater than 50 m/s, the wind is excessively strong, thereby causing wind ripples or depressions in the coating film.

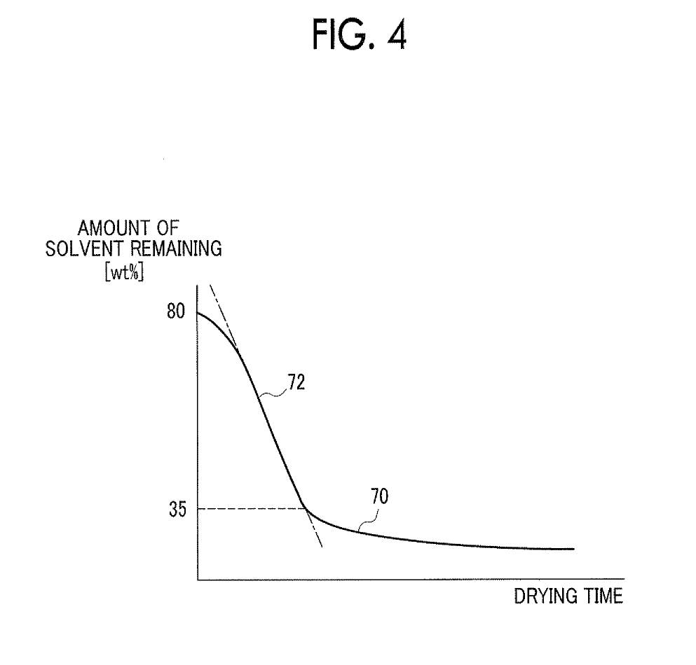

The drying rate of the coating film will be described below. FIG. 4 is a diagram illustrating a drying rate curve in which the amount of solvent (percentage of the amount of solvent remaining in the coating film) remaining in the coating film decreases with the lapse of drying time. In general, it is known that the amount of solvent remaining linearly decreases to a certain time point and slowly decreases thereafter as indicated by the curve 70. The former is referred to as a constant drying area and the latter is referred to as a decreasing drying area. Here, the slope of the linear part 72 in the constant drying area is defined as a drying rate.

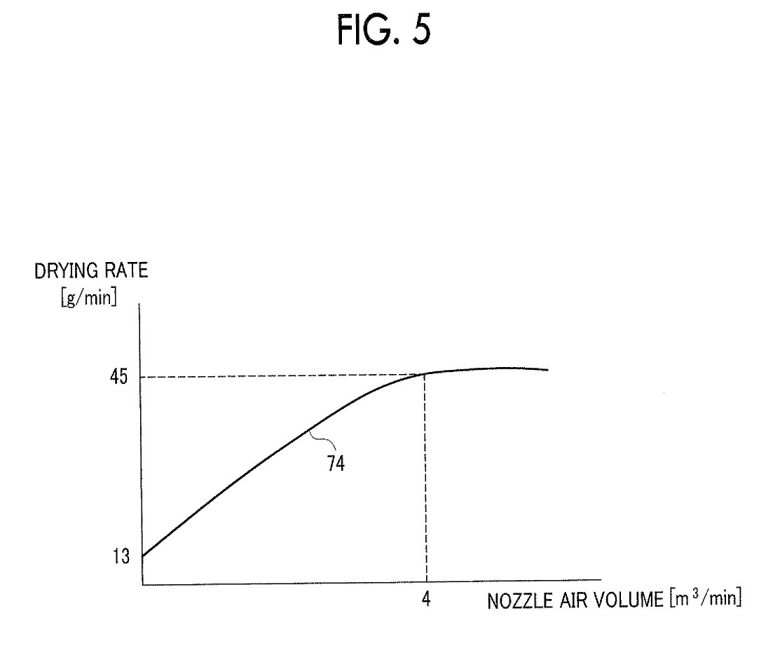

In this exemplary embodiment, the examination result of the relationship between the air volume (the air volume at the inlet 22) sent to the nozzle 16 and the drying rate is shown in FIG. 5. The drying rate curve 74 tends to linearly vary to a certain part in proportion to the air volume and to be saturated thereafter. It is thought that the saturation of the drying rate is because a diffusion rate of a solvent in the coating film has an upper limit.

Therefore, when the coating film is dried with an air volume with which the drying rate is saturated, the drying rate is constant in spite of slight unevenness in air volume. In this exemplary embodiment, the coating film is dried in this area to keep the drying rate constant.

The temperature of the hot air blown from the air blowing port 14 of the nozzle 16 is a temperature at which the solvent may be evaporated and is, for example, In the range of 100° C. to 200° C. at the air blowing port 14. When the temperature of the hot air is low, the drying time is extended and the dried coating film may not have a predetermined characteristic. When the temperature of the hot air is excessively high, depressions or bubbles may be formed in the coating film.

The core body 38 is rotated by a rotating device 43 in the drying process. The rotation direction is preferably the same direction as the direction in which the hot air flows. The reverse rotation may be possible. However, in this case, since wind ripples may be more easily formed in the coating film than in the case of the same direction, it is preferable to lower the wind speed.

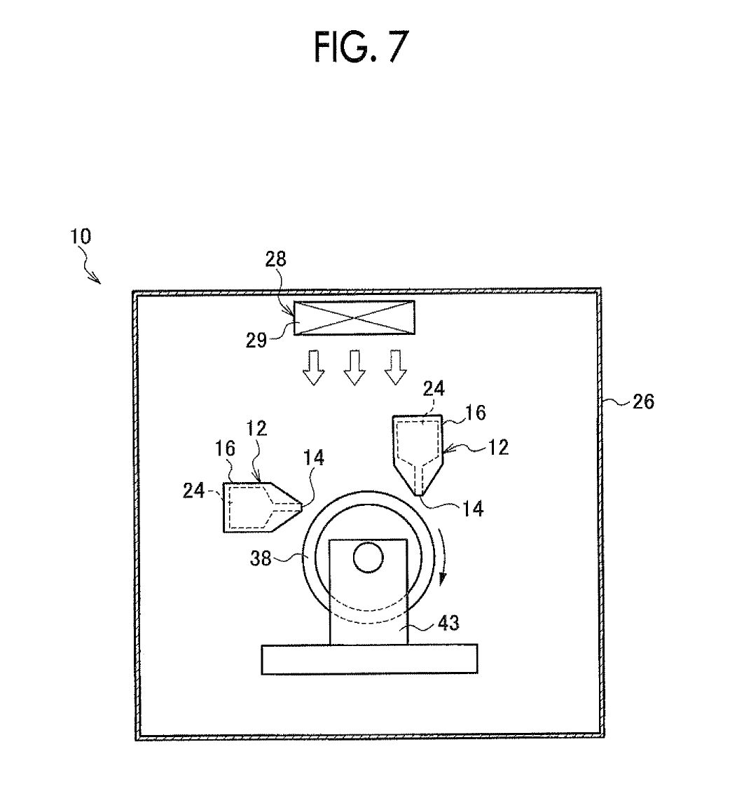

The air blower 12 may have plural nozzles 16 in the circumferential direction of the core body 38 (see FIG. 7).

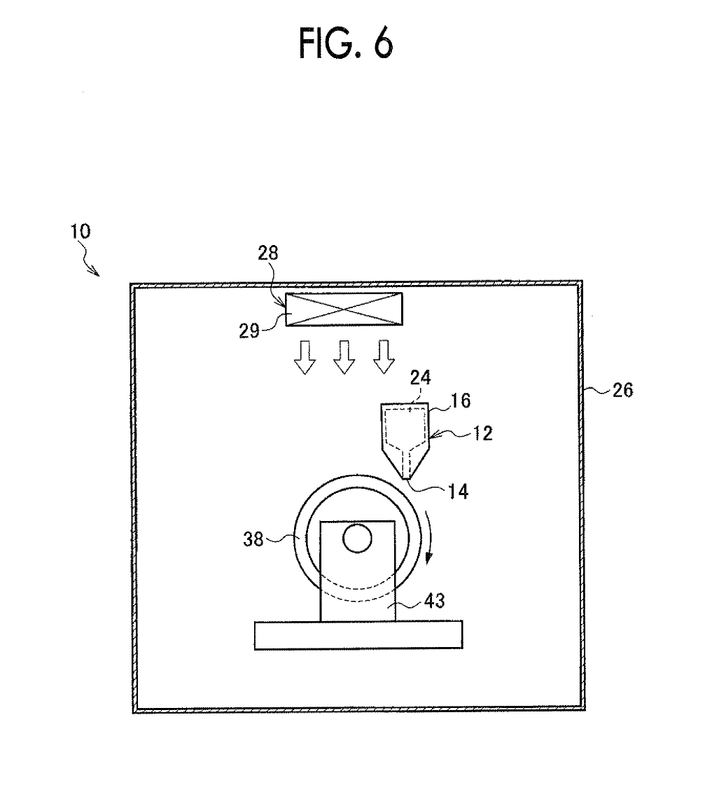

As shown in FIG. 6, the dryer 10 may be configured to have a drying furnace 26 in which the core body 38 and the air blower 12 are received. In order to maintain the temperature in the furnace high, the drying furnace 26 may be provided with a heat source other than the heat source for sending hot air to the nozzle 16. That is, as shown in FIG. 6, an air blower 28 sending hot air to the inside of the drying furnace 26 is disposed in the drying furnace 26. The air blower 28 has a configuration in which hot air is blown from the upside of the drying furnace 26 to the inside of the drying furnace 26, is discharged from the downside, and circulates in this way. The wind speed of the hot air is lower than the wind speed at the nozzle 16 and is set, for example, to a range of 0.5 to 2 m/s. That is, the wind speed of the hot air on the surface of the core body 38 is so low to ignore the hot air from the upside of the drying furnace 26.

The set temperature of the drying furnace 26 may be equal to or different from the temperature of the hot air blown from the nozzle 16. In this way, in the configuration in which the core body 38 and the air blower 12 are received in the drying furnace 26 to dry the coating film of the core body 38, the temperature of the core body 38 and air around the core body 38 is kept high and thus the drying of the entire coating film is promoted.

The blowing direction of the nozzle 16 may be directed to the downside as shown in FIG. 6 or may be set to any direction.

When the masking member is provided, the masking member is removed after the drying. By removing the masking member, a gap is formed between at least a part of the ends of the dried coating film and the core body. By blowing air into the gap and stripping the resin film obtained through the use of a heating process to be described later from the core body, an intermediate transfer belt may be easily and efficiently manufactured. Since an excessive force is not necessary for the stripping, it is possible to prevent defective products from being manufactured.

### Heating Process

The method of manufacturing an intermediate transfer belt according to this exemplary embodiment may include a heating process of forming a resin film by heating and hardening the dried coating film.

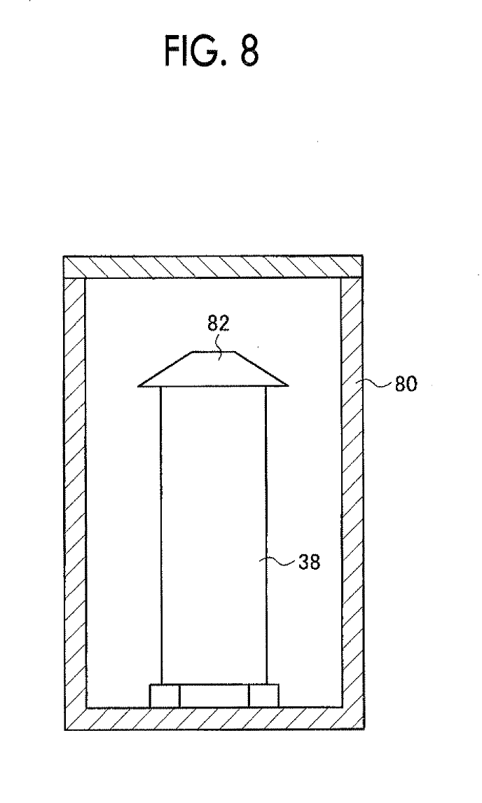

The heating process is necessary when the film forming resin includes a material such as a PI precursor causing a curing reaction by the application of heat. In the heating process, the core body is input into and heated by a heating furnace 80, as shown in FIG. 8. The heating temperature is preferably in the range of 250° C. to 450° C. and more preferably in the range of 300° C. to 350° C. An imidization reaction is caused by heating the PI precursor film for 20 to 60 minutes, whereby the PI resin film is formed. In the heating process, the heating is preferably carried out by gradually or at a constant rate before reaching the final heating temperature. When the film-forming resin is the PAI, the film is formed by only drying the solvent.

A roll provided to the rotating device has no heat resistance at such a high temperature. Accordingly, in the heating process, it is preferable that the core body is detached from the rotating device and is input into the heating furnace 80. In general, the core body is input into the heating furnace 80 in the state where the axis direction of the core body is set to be parallel to the direction of gravitational force, that is, upright vertically. The heating furnace 80 preferably has a configuration in which hot air is blown from the upside of the core body upright vertically so as to suppress the unevenness in inner temperature as much as possible. In order to prevent hot air from coming in direct contact with the top of the core body, a blocking member 82 blocking wind may be disposed above the core body, as shown in FIG. 8. The shape of the blocking member 82 is not particularly limited, as long as it may cover an end of the core body.

### Stripping Process

The method of manufacturing an intermediate transfer belt according to this exemplary embodiment includes a stripping process of stripping the coating film dried in the drying process from the core body.

In the stripping process, the core body 38 is taken out of the heating furnace 80 after ending the heating process and the formed film is stripped from the core body. As a result, an intermediate transfer belt is obtained. At this time, by blowing pressurized air into the gap at an end of the film formed by removing the masking member and releasing the close adhesion of the film and the core body, the film can be easily stripped. Since the end portion of the obtained film have defects such as creases or unevenness in thickness, unnecessary parts are cut out to complete the intermediate transfer belt. If necessary, the intermediate transfer belt may be subjected to a drilling process, a ribbing process, or the like.

The intermediate transfer belt obtained in this exemplary embodiment is a transfer medium to which an image is transferred from a photoreceptor or the like and which transfers the image onto a recording medium, and is used in an image forming apparatus such as an electrophotographic copier or a laser printer.

### EXAMPLES

Hereinafter, this exemplary embodiment will be described in more detail with reference to examples, but this exemplary embodiment is not limited to the following examples.

### Example 1

A carbon black (product name: Special Black 4, made by Degussa-Huls AG) with a solid mass ratio of 27% is mixed into 100 parts by mass of a PI precursor solution (product name: U-Varnish made by Ube Industries Ltd., with a solid concentration of 18% and a solvent of N-methylpyrrolidone), and the mixture is dispersed by the use of a counter-collision disperser (Geanus Py, made by Geanus Corporation), whereby a film-forming resin solution with viscosity at 25° C. of about 42 Pa·s is obtained.

A cylinder formed of SUS304 with an outer diameter of 600 mm, a thickness of 8 mm, and a length of 0.6 m is prepared, a disc having a thickness of 10 mm and an outer diameter which can be inserted into the cylinder and having four vent holes with a diameter of 150 mm is formed of the same SUS material as a holding plate, the disc is inserted into and welded to both ends of the cylinder and is used as a core body 38. The surface of the core body is roughened with Ra of 0.4 μm through a blast process using spherical alumina particles.

Subsequently, the surface of the core body 38 is coated with a silicone-based release agent (product name: SEPACOAT, made by Shin-Etsu Chemical Co., Ltd.) and the resultant is subjected to a baking process at 300° C. for 1 hour.

A masking member (product name: Scotch Tape #232, made by Sumitomo 3M Limited, including a crepe paper substrate and an acryl-based adhesive with a width of 24 mm) is attached to the entire circumferences of both end portions of the core body 38.

Subsequently, an underlying PI precursor coating film is formed by the use of a spiral coater shown in FIG. 1. The coating is carried out by connecting a mono pump as the pump 56 to the tank 54 containing 10 L of the film-forming resin solution 50, ejecting the resin solution by 60 ml per minute from the downward flow device 52, rotating the core body 38 in the direction of arrow B at 20 rpm, attaching the film-forming resin solution 50 from the downward flow device 52 to the core body 38, pressing the paddle 60 on the surface thereof, and moving the paddle in the axis direction (the direction of arrow C) of the core body 38 at a rate of 50 mm/min. The paddle 60 as a smoothing means is obtained by machining a stainless steel plate with a thickness of 0.2 mm into a width of 20 mm and a length of 50 mm. The coating range is from the position apart by 10 mm from an end of the core body 38 to the position apart by 10 mm from the other end thereof.

By continuing to rotate the core body for 5 minutes after the coating, a spiral hoop on the surface of the film disappears. As a result, a layer with a thickness of about 500 μm is formed. This thickness corresponds to a final thickness of 80 μm.

Thereafter, as shown in FIG. 7, the core body is rotated at 10 rpm and is input into the drying furnace 26 set to 150° C. The rotation direction of the core body 38 is the same (in the clockwise direction in FIG. 6) as the direction in which hot air flows. A HEPA filter 29 is disposed in the air blowing port of the air blower 28 provided to the upper part of the drying furnace 26, and hot air of 1.2 m/s is blown out to the lower part of the drying furnace 26 via the HEPA filter 29.

The air blower 12 installed in the drying furnace 26 includes two nozzles 16, as shown in FIG. 7. The two nozzles 16 have the same specification and have an air blow port 14 with a width of 1.5 mm and a length of 1.2 m and a cavity 24 formed therein. When air heated at 150° C. is blown to the inlet 22 at a flow rate of 0.1 m³/s, hot air at 150° C. is blown from the air blowing port 14 at a wind speed of 50 m/s. The nozzles 16 are disposed so that the angle of the nozzle 16 about the core body 38, that is, the angle θ formed by the flow of hot air and the tangential line S at the position corresponding to the core body 38, is 30° and the distance d between the core body 38 and the air blowing port 14 is 50 mm. The wind speed at the position corresponding to the core body 38 is 20 m/s and the temperature is 150° C., which is the same as the set temperature of the drying furnace 26. The two nozzles are located apart by 90° from each other about the center axis of the core body 38. By drying the coating film under these conditions for 15 minutes, the drying may be carried out until the amount of solvent remaining in the coating film is 40%. Then, the core body 38 is taken out and the masking member is removed.

Thereafter, as shown in FIG. 8, the core body 38 is taken out of the rotating device, is made to be upright vertically, and the blocking member 82 is mounted on the core body 38. The resultant shape has an outer diameter of 600 mm, a height of 120 mm, and a hole of 150φ formed at the center thereof, and it is obtained by machining an SUS304 plate with a thickness of 1 mm.

The core body 38 is input into the heating furnace 80 and is subjected to a heating process at 200° C. for 30 minutes and at 300° C. for 30 minutes, whereby the drying of the remaining solvent and the imidization reaction of the resin are simultaneously carried out.

After being cooled to a room temperature, pressurized air is blown into the gap between the core body 38 and the film and the resin film is stripped, whereby an intermediate transfer belt (endless belt) is obtained. The film thickness measured by the use of a dial gauge has an average value of 80 μm.

The electrical characteristics of the obtained intermediate transfer belt are measured using methods to be described later. The surface resistivity has an average of 10.78 Log Ω/□ and a deviation of 0.5.

### Example 2

In Example 1, the nozzle 16 in the drying furnace 26 is disposed so that the angle formed by the flow of hot air and the tangential line S of the core body 38 is 65° and the distance between the core body 38 and the air blowing port 14 is 50 mm. The wind speed of the hot air at the position corresponding to the core body 38 is 20 m/s, the temperature is 150° C., which is the same as the set temperature of the drying furnace 26. The two nozzles are located apart by 90° from each other about the center axis of the core body 38. The other conditions are the same as in Example 1.

By drying the coating film under these conditions for 15 minutes, the drying may be carried out until the amount of solvent remaining in the coating film is 40%, and the drying rate may be increased, similarly to Example 1.

The electrical characteristics of the obtained intermediate transfer belt are measured using methods to be described later. The surface resistivity has an average of 10.34 Log Ω/□ and a deviation of 0.8.

### Example 3

An SUS304 belt (metal belt) with an outer circumferential length of 2512 mm, a thickness of 0.2 mm, and a width of 0.5 m is prepared as the core body 38. The surface thereof is like a pearskin with Ra of 0.2 μm. The surface of the core body 38 except the parts 20 mm from both ends thereof is coated with a silicone-based release agent (product name: SEPACOAT, made by Shin-Etsu Chemicals Co., Ltd.) and the resultant is subjected to a baking process at 300° C. for 1 hour.

This metal belt is suspended on two rotation shafts with a diameter of 200 mm. Subsequently, the rotation shafts are rotated at 60 rpm, and the core body 38 except the parts 15 mm from both ends is coated with the same coating solution as in Example 1 by the use of a spiral coater. By continuing to rotate the core body for 5 minutes after the coating, a spiral hoop on the surface of the film disappears. As a result, a layer with a thickness of about 500 μm is formed. This thickness corresponds to a final thickness of 80 μm.

Thereafter, in the state where the metal belt is suspended on the rotation shafts, the rotation shafts are rotated at 30 rpm and the core body is input into a drying furnace not having a heat source. That is, the air blower 28 is removed from the drying furnace 26 shown in FIG. 6. The air blower 12 having a nozzle 16 is installed in the drying furnace 26. The nozzle 16 has the same specification as in Example 1, the angle θ formed by the flow of hot air and the tangential line S at the position corresponding to the core body 38 is set to 10°, and the distance d between the core body 38 and the air blowing port 14 is set to 50 mm. The wind speed at the position corresponding to the core body 38 is 20 m/s and the temperature is 140° C. By drying the coating film under these conditions for 16 minutes, the drying may be carried out until the amount of solvent remaining in the coating film is 40%. Since the core body 38 is thin, it may be dried for a short time by the use of only one nozzle 16. The rotating direction of the core body 38 is the same (the right rotation in the drawing) as the direction in which the hot air flows.

Thereafter, the core body 38 is detached from the rotation shafts, the cylindrical shape is maintained, and the core body 38 is input upright into the heating furnace and is subjected to a heating process at 200° C. for 15 minutes and at 300° C. for 30 minutes, whereby the drying of the remaining solvent and the imidization reaction of the resin are simultaneously carried out.

After being cooled to a room temperature, pressurized air is blown into the gap between the core body 38 and the film and the resin film is stripped, whereby an intermediate transfer belt is obtained. The film thickness measured by the use of a dial gauge has an average value of 80 μm.

The electrical characteristics of the obtained intermediate transfer belt are measured using methods to be described later. The surface resistivity has an average of 10.8 Log Ω/□ and a deviation of 0.5.

### Comparative Example 1

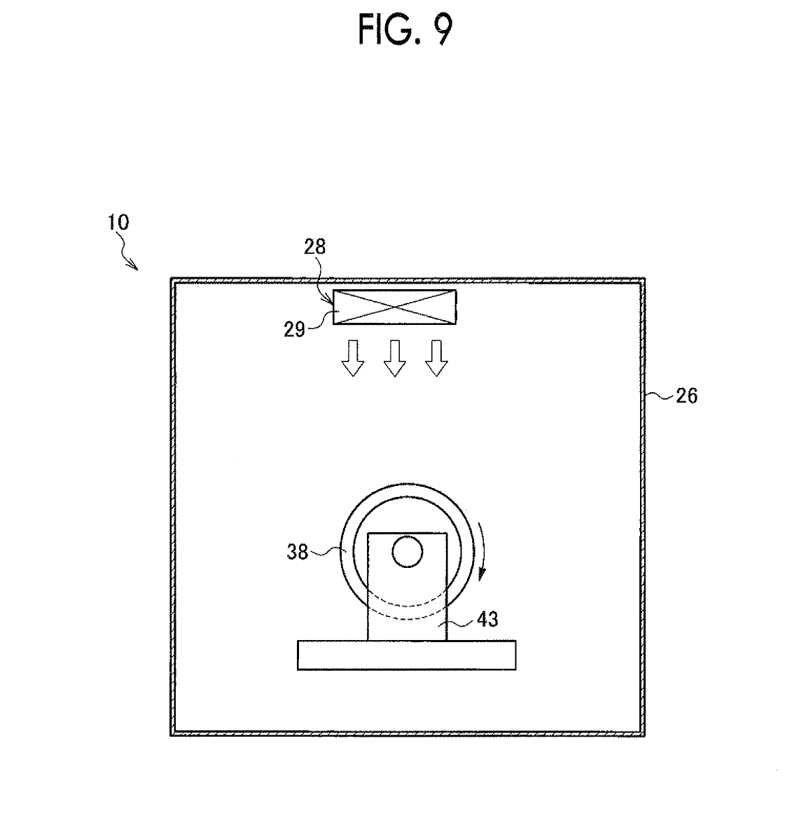

In Comparative Example 1, in the drying process of Example 1, the core body is input into the drying furnace 26 (having a configuration in which the air blower 12 is removed from the drying furnace 26 shown in FIG. 6 in Example 1) shown in FIG. 9 and is dried. In this comparative example, the time necessary until the amount of solvent remaining in the coating film is 40% is 26 minutes, which is longer by 9 minutes than that in Example 1. In Example 1, since strong hot air is blown out from the nozzle, the drying can be promoted by both temperature and wind. The other conditions are set the same, whereby an intermediate transfer belt is manufactured.

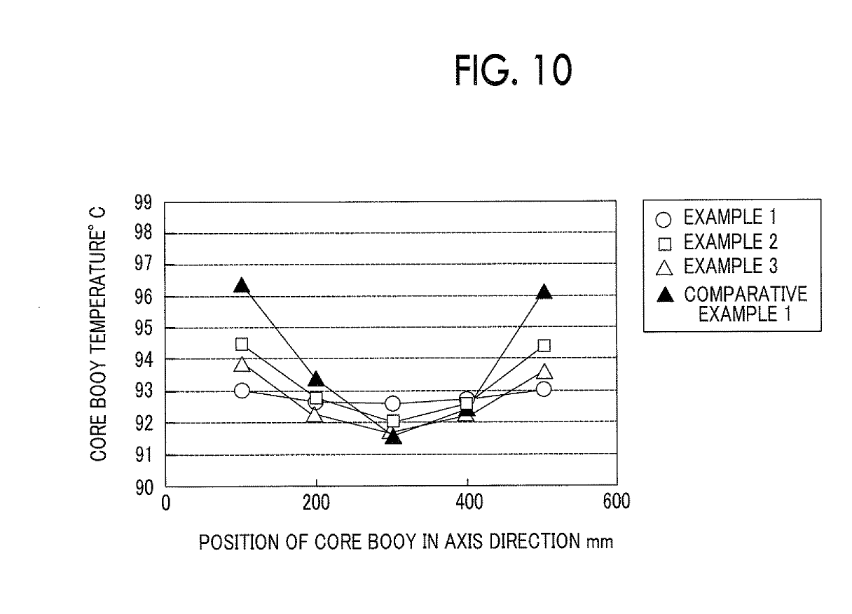

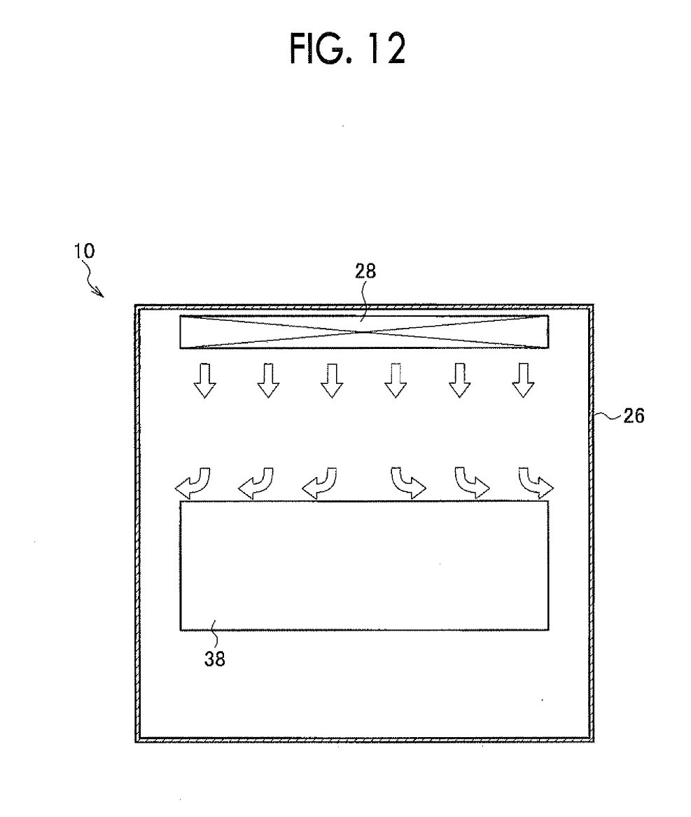

Here, the surface resistivity of the intermediate transfer belt is associated with the temperature of the core body during the drying and the resistance tends to decrease as the temperature is raised. The examination result of the temperature of the core body during the drying is shown in FIG. 10. That is, the temperature is measured from four points separated by 90° in the circumferential direction for each predetermined position in the axis direction of the core body and the results are arranged in the graph. As shown in FIG. 10, in Comparative Example 1, the temperature is high at both end portions of the core body and the temperature is low in the central portion. It is thought that this is because the hot air from the upside of the drying furnace flows to both ends in the axis direction, as shown in FIG. 12, after coming in contact with the core body, whereby the temperature in both end portions is raised. In Examples 1, 2, and 3, since the hot air comes in uniform contact with the core body in the axis direction and flows in the circumferential direction, the temperature is constant in the axis direction, compared with Comparative Example 1.

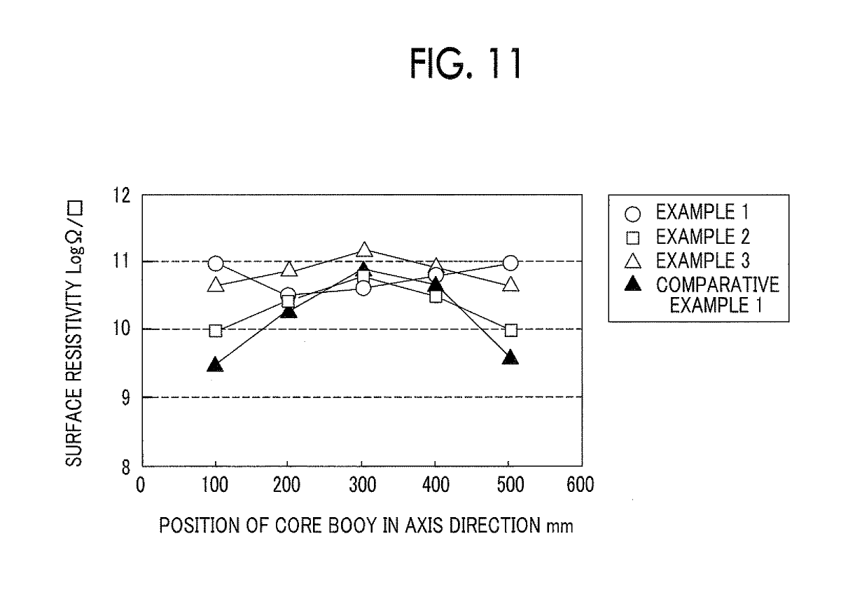

The surface resistance of the manufactured intermediate transfer belt is measured at the positions corresponding to the temperature-measured positions of the core body and the results are shown in FIG. 11. Example 1 exhibits an average of 10.78 Log Ω/□ and a deviation of 0.5, Example 2 exhibits an average of 10.34 Log Ω/□ and a deviation of 0.8, and Example 3 exhibits an average of 10.8 Log Ω/□ and a deviation of 0.5. On the contrary, Comparative Example 1 exhibits an average of 10.20 Log Ω/□ and a deviation of 1.4. Accordingly, it may be seen that the resistance deviation is improved in Examples 1, 2, and 3. In Examples 1, 2, and 3, it is considered that the remaining deviation is attributed to the unevenness in temperature of the heating reaction furnace.

The electrical characteristics are measured as follows.

### Surface Resistivity

The surface resistivity is a numerical value obtained by dividing a potential gradient in the direction parallel to the current flowing along the surface of a test sample by the current on the surface per unit width and is the same as the surface resistance between two electrodes which are located on the opposed sides of a square with a side length of 1 cm. The unit of the surface resistivity is formally Ω, but is marked in Ω/□ for the purpose of discrimination from simple resistance.

The measurement is carried out by applying a voltage to a ring electrode on the basis of JIS K6911 (1995) by the use of a digital ultrahigh resistance/minute current meter (R8340A, made by Advantest Corporation) and a UR probe of a double-ring electrode (MCP-HTP12) and Resitable (UFL MCP-ST03) (both made by Dia Instruments Co., Ltd.).

In measurement, a test sample is placed on the Resitable, the UR probe is brought into contact with the measuring surface, and a weight with a mass of 2.0±0.1 kg (19.6±1.0 N) is attached to the upper part of the UR probe so that a constant load is imposed on the test sample. The voltage application time for measurement is set to 10 seconds.

When the read value of the digital ultrahigh resistance/minute current meter R8340A is R and the surface resistivity correction coefficient of the UR probe MCP-HTP12 is RCF(S), RCF(S)=10.0 is obtained from the catalog of “resistivity meter series” by Dia Instruments Co., Ltd. and thus the surface resistivity ρs is expressed by Expression 1.

ρs(Ω/□)=R×RCF(S)=R×10.0 Expression 1

The invention is not limited to the above-mentioned embodiment, but may be modified, changed, and improved in various forms. For example, some of the above-mentioned modifications may be appropriately combined.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A tubular member manufacturing method comprising:
coating the surface of a rotating core body with a resin solution to form a coating film thereon while rotating the core body with the axis direction set to be horizontal;
drying the coating film by blowing air to the core body with a saturated air volume with which a drying rate of the coating film is saturated; and
stripping the dried coating film from the core body.

2. The tubular member manufacturing method according to claim 1, wherein the wind speed of the air coming in contact with the coating film in the drying of the coating film is in a range of 5 to 50 m/s.

3. The tubular member manufacturing method according to claim 1, wherein the drying of the coating film includes:
setting the core body into a drying furnace into which heated air is supplied, and
blowing air to the core body with the saturated air volume from an air blowing port of an air blower installed in the drying furnace to dry the coating film.

4. The tubular member manufacturing method according to claim 2, wherein the drying of the coating film includes:
setting the core body into a drying furnace into which heated air is supplied, and
blowing air to the core body with the saturated air volume from an air blowing port of an air blower installed in the drying furnace to dry the coating film.

5. The tubular member manufacturing method according to claim 3, wherein the drying of the coating film includes:
blowing air to the core body from the air blowing port formed in a slit shape extending in the axis direction of the core body.

6. The tubular member manufacturing method according to claim 4, wherein the drying of the coating film includes:
blowing air to the core body from the air blowing port formed in a slit shape extending in the axis direction of the core body.
